(19) United States
(12) Patent Application Publication
(10) Pub. No.: US 2015/0100674 A1
(43) Pub. Date: Apr. 9, 2015

(54) DEVICE FOR CONFIGURATION OF ETHERNET EQUIPMENT AND METHOD FOR CONFIGURATION OF ETHERNET EQUIPMENT USING SUCH A DEVICE

(71) Applicant: Schneider Electric Industries SAS, Rueil-Malmaison (FR)

(72) Inventors: Thierry CHICHE, Saint Ismier (FR); Pascal HAMPIKIAN, Paris (FR); Jun YE, Shanghai (CN)

(73) Assignee: Schneider Electric Industries SAS, Rueil-Malmaison (FR)

(21) Appl. No.: 14/504,599

(22) Filed: Oct. 2, 2014

(30) Foreign Application Priority Data
Oct. 7, 2013 (FR) 13 59706

(51) Int. Cl. H04L 12/24; H04L 29/12

(52) U.S. Cl. CPC H04L 41/0806; H04L 61/2007; H04L 61/6068
USPC 709/222

(57) ABSTRACT

This configuration device (10) enables the configuration of a plurality of equipment units (4a, 4b, 4c), each equipment unit (4a, 4b, 4c) having an Ethernet connector (14a, 14b, 14c). This configuration device comprises a mating Ethernet connector (18) capable of being connected to each Ethernet connector (14a, 14b, 14c), a first recording and storage means (72) for recording and storing the reference network settings, and a downloading means (56) capable of downloading the reference network settings on to each equipment unit (4a, 4b, 4c). The configuration device also comprises a detection means (58) capable of detecting the connection of the configuration device to a corresponding equipment unit (4a, 4b, 4c), and an assignment means (60) capable of assigning, following the detection of the said connection, a unique IP address to the equipment unit to which the configuration device is connected. The said unique IP address is included in the reference network settings meant to be downloaded into the corresponding equipment unit.

The present invention relates to a configuration device for configuring of a plurality of equipment units, each equipment unit having an Ethernet connector, and the device comprising a mating Ethernet connector capable of being connected successively to the Ethernet connector of each equipment unit.

The invention also relates to a configuration method for configuring of a plurality of equipment units, each having an Ethernet connector, by making use of such a device. In the domain of configuration of equipment and devices having wired Ethernet connectivity and intended to be subsequently connected on the same communication network, it is a known practice to use a computer that an operator connects on to each equipment unit one after the other. Following the connection of the computer to each equipment unit, the operator then launches a programming software on the computer and proceeds to perform the configuration of each equipment unit themselves. The configuration of each equipment unit is generally performed: by manually configuring the IP (Internet Protocol) address of the computer used in conformity with the IP address of the equipment unit to which it is connected, by entering the current IP address of the equipment unit in the programming software in order to enable communication between the computer and the corresponding equipment unit, and manually assigning configuration programmes and a new address to the corresponding equipment unit in order to ensure that its IP address is appropriate for the network to which the equipment unit is intended to be connected. This operation is thus repeated for each equipment unit and performing the configuration of all the equipment units is particularly long and tedious. In addition, due to the assignment of the IP address for each equipment unit being done manually, the uniqueness of the IP address of the Ethernet equipment units is not guaranteed.

It is also known practice to use an automatic IP address server, such as a DHCP (from the term: Dynamic Host Configuration Protocol) server, in order to assign an IP address to each equipment unit that one intends to connect to the same network. However, this method requires the establishment of a predefined IP address table at the level of the DHCP server, which allocates the IP addresses based on recognition of each equipment unit that makes the request for an IP address. Thus, according to this method, the implementation of a DHCP server is necessary, and each equipment unit must be capable of making the request for an IP address from the DHCP server. More specifically, this method requires that the network to which the equipment units are connected be operational, that the DHCP server be connected and configured and that each equipment unit have a unique identifier that is shared with the DHCP server used during the assignment of the IP address by the DHCP server. This is achieved by making use of a physical mechanism of a suitable type such as thumb wheel or jog wheel, or by means of unit configuration of each equipment unit and with a unique identifier that is shared with the DHCP server, all of which make this operation long and complex and requires the use of a computer.

The goal of the invention is to assign, in a simple manner, an IP address to one or more Ethernet equipment units intended to be part of a network, in particular without using dedicated tools for configuring IP addresses of equipment units involving the use of a computer or tablet, and without the prior physical constitution of the network. The objective of the invention is to provide a configuration device for configuring multiple Ethernet equipment units that provides the ability to perform the configuration of Ethernet equipment units, in a simple, fast, and unitary manner.

To this end, the object of the invention relates to a configuration device for configuring one or more equipment units, each equipment unit having an Ethernet connector, and the device comprising an mating Ethernet connector capable of being connected successively to each Ethernet connector via a point to point link, a first recording and storage means for recording and storing the reference network settings, and a downloading means capable of downloading the reference network settings on each equipment unit. In accordance with the invention, the device comprises a detection means capable of detecting the connection of the device to a corresponding equipment unit, and an assignment means capable of assigning, following the detection of the said connection, a unique IP address to the equipment unit to which the device is connected, the said unique IP address being included in the reference network settings meant to be downloaded into the corresponding equipment unit.

With the help of the invention, the reference network settings and in particular a guaranteed unique IP address, are downloaded into each equipment unit, following the connection of the configuration device successively with each equipment unit, and this without any further manipulation on the part of the operator other than only ensuring the connection of the configuration device to each equipment unit. In addition, the reference network settings are automatically assigned following each connection made by the device to one of the equipment units, and the IP address assigned being unique for each equipment unit, this provides the ability to ensure the uniqueness of the IP address configured on each equipment unit. Furthermore, the detection means provides the ability to detect the connection of the device to one of the equipment units in an automatic manner, without pre-configuration of the device.

In contrast to the use of a DHCP server, the device according to the invention automatically assigns, after its being connected to the corresponding equipment unit, a unique IP address to the equipment unit, without the latter having to send a request to the device asking for an IP address. In addition, the use of a DHCP server requires, prior to the device being connected to the equipment unit, that one associate with each IP address a unique identifier, in alphanumeric form, for the corresponding equipment unit, which necessarily involves the use of an additional logic device, the mandatory configuration of this equipment and the assigning of a unique identifier to each corresponding equipment unit.

According to advantageous aspects of the invention, the configuration device further includes one or more of the following characteristic features, taken into consideration individually or in accordance with all technically permissible combinations:
the first recording and storage means is capable of saving and storing an assignment table comprising of at least, for each equipment unit, one configuration element selected from among the reference network settings, a configuration file and one or more programmes meant to be executed by the equipment units, the said one or more configuration elements being meant to be downloaded on to the corresponding equipment unit, whereas the device includes a management means capable of managing the assignment table, while the assignment means is capable of assigning to the equipment unit to which it is connected, the said one or more configuration elements, based on the assignment table, and the downloading means is capable of downloading on to the equipment unit to which it is connected the one or more configuration elements assigned;
the reference network settings include a reference IP address, while the assignment means is capable of incrementing by a reference value the reference IP address in order to determine the unique IP address associated with the corresponding equipment unit, following each connection made by the device to one of the equipment units;
an indicator is associated with each equipment unit, whereas the device comprises a first identification means capable of identifying the indicator of the equipment unit to which it is connected, and furthermore the said one or more configuration elements contained in the assignment table are functions of the indicator associated with each equipment unit;
the reference network settings include a reference IP address for each different indicator whereas, following each connection made by the device to one of the equipment units, the assignment means is capable of incrementing by a reference value the reference IP address associated with the indicator of the corresponding equipment unit in order to determine the unique IP address associated with the corresponding equipment unit;
the device comprises a second identification means capable of retrieving an identifier of each equipment unit, the identifier being unique for each equipment unit, while the device includes a second recording and storage means capable of saving and storing each operation executed by the downloading means and capable of generating a traceability file for the operations performed, and whereas the second recording and storage means associates the unique identifier of the corresponding equipment unit with each equipment unit and with each operation saved and stored;
the second recording and storage means is capable of saving and storing the said one or more configuration elements downloaded on to each equipment unit, whereas the device includes a server, capable of again downloading the said one or more configuration elements on to each equipment unit, a generation means capable of generating a configuration file from the server based on the said one or more configuration elements saved and stored by the second recording and storage means, and a file export member for exporting the configuration file to the server;
the device is portable and comprises an autonomous electrical power supply, whereas the device also comprises a wireless communication means;

The object of the invention also relates to a configuration method for configuring a plurality of equipment units by making use of a configuration device, each equipment unit having an Ethernet connector, the device comprising a mating Ethernet connector capable of being connected successively to each Ethernet connector via a point to point link, the method comprising of the following steps:
a) the saving and storing of reference network settings,
b) the successive connection of the device to each equipment unit,
c) the downloading of the reference network settings on to each equipment unit.

In accordance with the invention, the method includes, prior to the step of downloading and after the step of connecting, the following steps of:
b1) the detection by the device of the connection to the equipment unit to which it is connected, and
b2) the assignment by the device, following the detection of the said connection, of a unique IP address to the equipment unit to which the device is connected, the said unique IP address being included in the reference network settings to be downloaded into the corresponding equipment unit.

According to other advantageous aspects of the invention, the configuration method includes one or more of the following characteristic features, taken into consideration individually or in accordance with all technically permissible combinations:
prior to the step of recording and storing the method includes the following step:
   a1) the definition of an assignment table comprising of at least, for each equipment unit, one configuration element selected from among: the reference network settings, a configuration file and one or more programmes meant to be executed by the equipment units, the said one or more configuration elements being meant to be downloaded on to the corresponding equipment unit to which the device is connected,
   and whereas during the step of assignment the device assigns to the equipment unit to which it is connected the said one or more configuration elements, based on the assignment table, and while during the step of downloading, the downloading means downloads on to the corresponding equipment unit the said one or more configuration elements assigned;
during the step of recording and storing a user records and stores in the device a reference IP address, whereas following each connection made by the device to one of the equipment units, the device performs the steps of assignment and downloading, while during the step of assignment, the reference IP address is incremented by a reference value, and while during the step of downloading, the reference IP address incremented is downloaded on to the equipment unit to which the device is connected and recorded and stored as the new reference IP address;
during the step of definition, the data and information contained in the assignment table are functions of an indicator associated with each equipment unit, whereas after the detection step, the method includes a further step consisting of the identification of the indicator of the equipment unit to which it is connected, and while during the assigning step, the said one or more configuration elements assigned depend on the indicator of the equipment unit to which the device is connected;
during the step of recording and storing, a user records and stores in the device a reference IP address for each different indicator, following each connection made by the device to one of the equipment units, the device performs the steps of identification, assignment and downloading, while, during the assignment step, the reference IP address associated with the indicator of equipment unit, identified during the identification step, is incremented by a reference value, and whereas during the downloading step, the incremented reference IP address is downloaded on to the equipment unit to which the device is connected and recorded and stored as the new reference IP address associated with the corresponding indicator;
following the step of downloading, the device performs a subsequent step consisting of the test to ensure that the downloading of network settings has been successfully performed, by connecting the device to the equipment unit based on using the network settings downloaded during the downloading step;
the device includes a server capable of again downloading the said one or more configuration elements on to each equipment unit, while following each step of downloading the device carries out the following steps:
   the saving and storing of the said one or more configuration elements downloaded on to each equipment unit,
   the generation of a configuration file from the server based on the configuration elements saved and stored, and
   the exporting of the configuration file to the server.

The invention will be better understood and other advantages thereof will appear more clearly in the light of the description that follow here below, provided by way of non-limiting example, and with reference being made to the drawings in which:

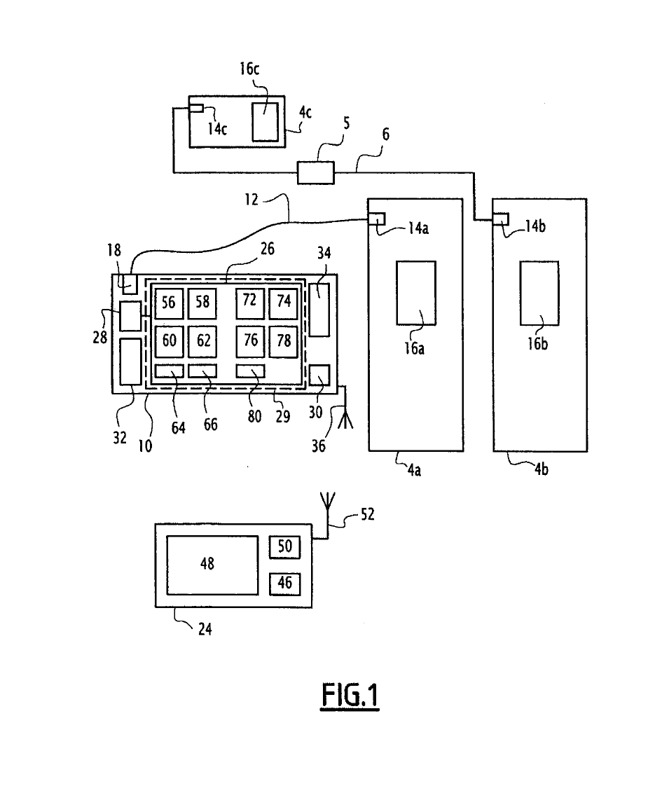

FIG. 1 is a schematic representation of a plurality of equipment units intended to be part of a same given network, and a configuration device, in accordance with the invention, connected to one of the equipment units;

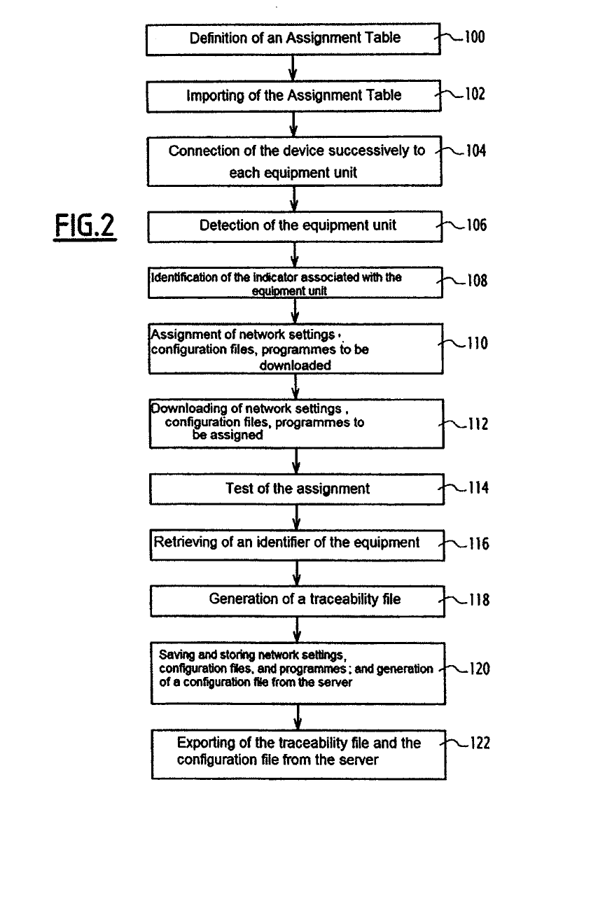

FIG. 2 is a flowchart of the steps of a configuration method for configuring a plurality of equipment units having an Ethernet connector, according to a first embodiment of the invention; and

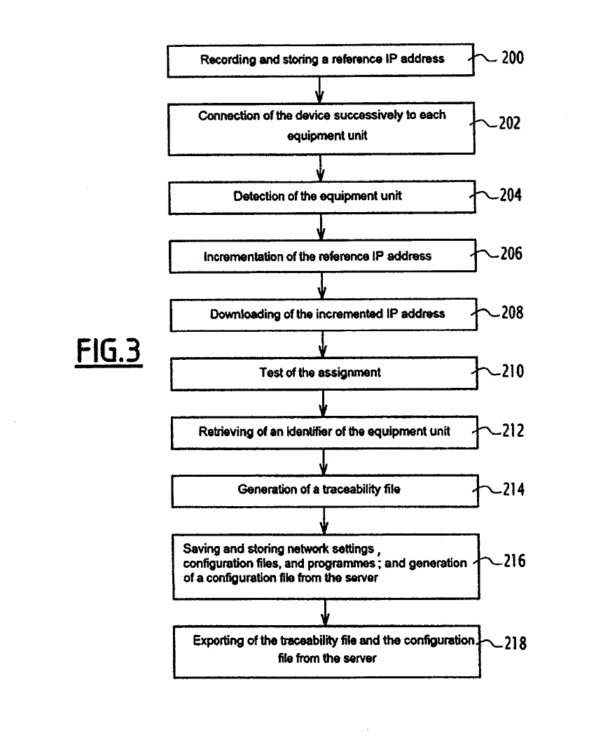

FIG. 3 is a flowchart of the steps of a configuration method for configuring a plurality of equipment units having an Ethernet connector, according to a second embodiment of the invention.

In the FIG. 1, a first 4a and a second 4b equipment units are represented and are intended to be connected via a network switch 5 to a third control equipment unit 4c for controlling the first 4a and second 4b equipment units in order that the equipment units 4a, 4b, 4c can form a communication network once their respective IP addresses have been configured. In the representation shown in the FIG. 1, only the second equipment unit 4b is connected to the third equipment unit 4c via the switch 5 and a first Ethernet link 6.

In addition, a configuration device 10 for configuring of equipment units 4a, 4b, 4c is shown and is connected to the first equipment unit 4a via a second Ethernet link 12, between the configuration device 10 and the first equipment unit 4a. More specifically, the device 10 is connected to the corresponding equipment unit via the link 12 which is a point to point link.

First, second and third equipment units 4a, 4b, 4c each include an Ethernet connector 14a, 14b, 14c and a data processing unit 16a, 16b, 16c.

The third equipment unit 4c is, for example, a programmable logic controller, capable of controlling the first and second equipment units 4a, 4b, once the first, second and third equipment units 4a, 4b, 4c have been configured via the configuration device 10 and once the first equipment unit 4a has been disconnected from the configuration device 10 and connected to the switch 5 via a connector 14a thereof.

The device 10 comprises an Ethernet connector 18 in a manner such that the Ethernet link 12 is established between the mating connector 18 and one of the connectors 14a, 14b, 14c during the configuration of the equipment units 4a, 4b, 4c. In FIG. 1, the

Ethernet link 12 is disposed between the mating connector 18 and the connector 14a of the first equipment unit 4a.

The device 10 is capable of communicating via a radio link with a configuration module 24 of the device.

The device 10 comprises a memory storage 26 and a processor 28 associated with the memory storage 26, the memory storage 26 and the processor 28 form a computing unit 29. The device 10 also includes a data server 30, a battery 32, a radio transmitter/receiver 34 and a radio antenna 36.

The data processing units 16a, 16b, 16c are capable of managing the operation of the equipment units 4a, 4b, 4c and of receiving the configuration elements sent from the device 10.

The configuration module 24 comprises of a display member 46, a data processing element 48, a radio transmitter/receiver 50 and a radio antenna 52.

By way of a variant, the configuration module 24 includes an Ethernet connector not shown and is connected to the device 10 via an Ethernet link.

The memory storage 26 is capable of storing a downloading software application 56 for downloading the reference network settings on to each equipment unit 4a, 4b, 4c and more generally at least one configuration element selected from among: the reference network settings, a configuration file and one or more software programmes meant to be executed by the equipment units 4a, 4b, 4c. The reference network settings include at least one unique IP address for each equipment unit 4a, 4b, 4c and are also able to include, for example, a subnet mask or a default gateway.

The memory storage 26 is also capable of storing a detection software application 58 for detecting the connection of the device 10 to the corresponding equipment unit 4a, to which it is connected, and an assignment software application 60 for assigning the unique IP address, to be downloaded into the corresponding equipment unit, to the equipment unit to which the device 10 is connected. The assignment software application 60 is capable of ensuring that the unique IP address is taken into consideration by the equipment unit as also the fact that the IP address downloaded on to each equipment unit is different. More generally, the assignment software application is capable of assigning the said one or more configuration elements.

The memory storage 26 is also capable of storing a first identification software application 62 for identifying an indicator associated with each equipment unit 4a, 4b, 4c and a second identification software application 64 for identifying an identifier of each equipment unit, the said identifier being unique for each equipment unit 4a, 4b, 4c.

The memory storage 26 is moreover also capable of storing a configuration element reading software application 66 for reading the unique IP address, and more generally, for reading the said configuration element or elements, used by the equipment unit 4a to which it is connected, a first recording and storing software application 72 for recording and storing the reference network settings and a management software 74 for managing the assignment table comprising the said configuration element or elements for each equipment unit 4a, 4b, 4c.

The memory storage 26 also includes a second recording and storing software application 76 for recording and storing each operation performed by the downloading software application 56, a generation software 78 for generating a configuration file from the server 30, a file export member 80 for exporting the configuration file to the server 30.

The processor 28 is capable of executing and running the software applications stored in the memory storage 26

The server 30 upon being configured, is capable of reassigning to each equipment unit 4a, 4b, 4c, the said one or more configuration elements included in the assignment table and downloaded using the downloading software application 56 on to each equipment unit 4a, 4b, 4c.

The battery 32 is capable of powering the device 10 which is thus movable and autonomous. By way of a variant, the device 10 is supplied with power via the Ethernet link 12.

The radio transmitter/receiver 34 and the radio antenna 36 are capable of transmitting radio signals directed to the radio transmitter/receiver 50 and the radio antenna 52 of the configuration module 24. Thus, the device 10 is connected to the configuration module 24 by radio link.

The display member 46 is capable of displaying information, such as network settings, read by the reading software 66 and transmitted by means of the transmitter/receiver 34 and the antenna 36 to the configuration module 24. More generally, the display member 46 is capable of displaying the said one or more configuration elements downloaded on to each equipment unit 4a, 4b, 4c.

The data processing element 48 is capable of saving and storing the assignment table. The assignment table is, for example, downloaded to the data processing element 48 via a USB, or WIFI connection, or via the radio antenna 52. The processing element 48 is capable of communicating with the device 10 and transferring to the device 10, and more particularly to the first recording and storing software application 72, the said assignment table. The data processing element 48 is also capable of defining and/or saving and storing the reference network settings, the automatic assignment logic, that is to say, for example, an IP address range by type of equipment, the configuration file and the programme or programmes downloaded on to each equipment unit and transmitted by the device 10.

The downloading software 56 is capable of downloading the reference network settings, stored by the first recording and storing software 72, on each equipment unit 4a, 4b, 4c. More generally, the downloading software 56 is capable of downloading, into the equipment unit 4a to which the device 10 is connected, the said one or more configuration elements contained and defined in the assignment table and corresponding to the equipment unit 4a to which the device 10 is connected.

The detection software 58 is capable of detecting the connection of the device 10 to the equipment unit 4a to which it is connected, that is to say, that it is capable of establishing communication via the Ethernet link 18 with the equipment unit 4a. More generally, the detection software is capable of detecting the connection of the device 10 to each equipment unit 4a, 4b, 4c to which it is connected.

The assignment software 60 is capable of assigning, following each connection made by the device 10 to one of the equipment units 4a, 4b, 4c, the unique IP address included in the assignment table and more precisely in the network settings, and corresponding to the equipment unit. More generally, the assignment software application 60 is able to assign to the equipment units 4a to which the device 10 is connected the one or more configuration elements to be downloaded on to the corresponding equipment unit 4a. Thus, the assignment software application 60 is capable of assigning the said one or more configuration elements to be downloaded on to each equipment unit, based on the assignment table and the downloading software is capable of downloading on to the equipment unit 4a to which it is connected the said element or elements assigned.

The first identification software 62 is able to identify the indicator associated with the equipment units 4a, 4b, 4c to which it is connected, it being known that the configuration elements contained in the assignment table are based on the indicator associated with each equipment unit. The indicator for example, corresponds to the type of the equipment unit 4a, 4b, 4c, that is to say, that it provides the ability for example to determine whether the equipment unit is a human machine interface, or a variable speed drive or a servo motor or some other type of industrial sensor-actuator connectable to an Ethernet network, or a programmable logic controller. Thus, based on the indicator identified by the first identification software 62, the configuration files and programme downloaded by the downloading software 56 on to each equipment unit 4a, 4b, 4c differ. It thus appears that for equipment units having the same indicator, the configuration files and programme downloaded are identical and that the assignment software 60 is capable of assigning the said one or more configuration elements to be downloaded on to each equipment unit, based on the said indicator.

The second identification software application 64 is capable of retrieving an identifier of each equipment unit 4a, 4b, 4c, for example an equipment unit reference item such as a serial number associated with an equipment unit family. The second identification software application 64 is also able to verify that the configuration elements downloaded on to the equipment unit 4a, to which the device 10 is connected have indeed been taken into account and stored by the corresponding equipment unit 4a. The second identification software is in addition capable of transmitting a signal to an operator in order to indicate to them that the configuration elements have indeed been downloaded on to the said equipment unit 4a. The operator then knows that the entire sequence for downloading of network settings has been successfully executed and that they may then remove the cable connection from the said equipment unit 4a so as to connect it on to a new equipment unit so that the latter may be configured in its turn. Thus every operation performed by the downloading software 56 is capable of being associated with the identifier of the corresponding equipment unit.

The reading software 66 is capable of reading and retrieving the network settings and more generally, the said one or more configuration elements to be downloaded on to each equipment unit.

By way of a variant, the device 10 includes a display means, not shown, capable of displaying the network settings read by the reading software 66.

The first recording and storing software application 72 is capable of storing the assignment table presented here above.

The management software 74 is capable of managing the assignment table and modifying it, for example, based on information received from the data processing element 48.

The second recording and storing software application 76 is capable of saving and storing every operation performed by the downloading means 56 and of generating a traceability file for the operations performed. In addition, the second recording and storing software application 76 is capable of associating the identifier of the corresponding equipment unit to each operation saved and stored, and is capable of saving and storing the configuration elements downloaded on to each equipment unit 4a, 4b, 4c. In addition, the second recording and storing software application 76 is capable of recording and storing a validation related information item transmitted by the second identification software application 64 and indicating whether the configuration elements have appropriately been taken into account and recorded and stored by the equipment unit 4a to which the device 10 is connected.

The generation software application 78 is capable of generating a configuration file from the server 30 based on the operations saved and stored by the second recording and storing software application 76 and, more generally, based on the said one or more configuration elements downloaded on to each equipment unit 4a, 4b, 4c, and stored by the second recording and storing software application 76.

The file export member 80 is capable of sending to the server 30 the configuration file generated by the generation software application 78.

The device 10 thus provides the ability to automatically download the said one or more configuration elements on to each equipment unit 4a, 4b, 4c without need for specific operations to be performed on the part of the operator, but by simply connecting the device 10 to each equipment unit 4a, 4b, 4c. The said one or more configuration elements preferably correspond at least to the reference network settings, such as the IP address to be downloaded on to each equipment unit 4a, 4b, 4c. The device 10 thus enables the automatic configuration of the IP address of each equipment unit in a quick and efficient manner, simply by connecting the device 10 to each equipment unit 4a, 4b, 4c.

In the case presented in the FIG. 1, the list of IP addresses to be downloaded on to each equipment unit 4a, 4b, 4c is suitable for being defined by the user, associated with an equipment unit in particular, communicated to the device via the data processing element 48 and the assignment table, and saved and stored on the device by making use of the first recording and storing software application 72.

By way of a variant, the first recording and storing software application 72 is capable of storing a reference IP address, and the assignment software application 60 includes an automatic assignment logic for automatically assigning the network settings and is thus capable of incrementing by a reference value the reference IP address, upon each connection made by the device to one of the equipment units 4a, 4b, 4c, and of assigning to the corresponding equipment unit the reference IP address once the latter has been incremented. Thus, upon each connection made by the device 10 to one of the equipment units 4a, 4b, 4c, the IP address downloaded by making use of the downloading software application 56, on to the corresponding equipment unit, is different, which makes it possible to ensure the uniqueness of the IP address of each equipment unit.

According to another variant embodiment, the recording and storing software application 72 is capable of storing a reference IP address for each different indicator associated with each equipment unit 4a, 4b, 4c, that is to say for example, for each different type of equipment. The assignment programme 60 is then capable of incrementing by a reference value the reference IP address corresponding to the indicator associated with the equipment unit to which the device 10 is connected, and of assigning to the corresponding equipment unit the incremented reference IP address.

The device 10 thus provides the ability to assign different IP addresses to the equipment units 4a, 4b, 4c, intended to be part of the same network, and without the need for pre-configuration enabling the recognition of the Ethernet equipment unit by the device 10.

Moreover, in the event of the number of equipment units to be configured being quite significant, that is to say of the order of several hundreds, the device 10 provides the ability to quickly configure these equipment units and to do this without performing any particular operation, apart from connecting the device 10 to each equipment unit 4a, 4b, 4c. The time for configuring each equipment unit is thus greatly reduced.

The choice of the mode of operation of the device, that is to say via an assignment table or indeed an automatic incrementation of the reference IP address is appropriate for the selection to be made by the data processing element 48, which transmits the information to the first recording and storing software 72.

The operation of the configuration device 10, according to the invention will now be explained with the aid of the FIGS. 2 and 3, which correspond to two different embodiments.

In the first embodiment of the invention, corresponding to the FIG. 2, during an initial step 100, the assignment table is computed and with each equipment unit are associated, preferably, the network settings, a configuration file, and one or more software programmes. Then, during a subsequent step 102, the assignment table is imported from the configuration module 24 to the device 10 and, more specifically, by the first recording and storing software application 72.

During a subsequent step 104, the device 10 is successively connected in turn to each equipment unit 4a, 4b, 4c.

Following each connection being made, the device 10 automatically performs a step 106 of detecting the corresponding equipment unit through the use of one protocol or multiple consecutive, standard or proprietary Ethernet protocols until the corresponding equipment unit 4a is detected. The one or more Ethernet protocols include, for example the following protocols: SNMP (for the English term: Simple Network Management Protocol), the DPWS-discovery protocol (for the English term: Devices Profile for Web Services-discovery), DHCP (Dynamic Host Configuration Protocol), and BOOTP (Bootstrap Protocol). By way of a variant, the protocol used consists of an ARP (Address Resolution Protocol) frame exchange operation, or others. A subset of these protocols to be supported in parallel by the device 10 it may use them successively until one exchange operation proves to be successful.

In case of transmission of DHCP/BOOTP frames by the equipment unit, the assignment software application 60 for assigning network settings uses these DHCP/BOOTP protocols only to detect the presence of the equipment unit and thereafter to download therefrom the network settings, but then will subsequently disable the use of these DHCP/BOOTP protocols in order to ensure that upon the equipment unit being powered up on the subsequent occasion, it is prevented from again despatching a new DHCP/BOOTP request and from erasing from its memory the configuration of the network settings previously downloaded by the device. Indeed it should be reiterated that it is in the interest of the device to download the Ethernet network settings for network architectures not yet built.

Then during a step 108, the device 10, and in particular the first identification software application 62, identifies the indicator associated with the corresponding equipment unit, which provides the ability to determine for example the type of device and thus to ascertain which configuration file, which programme or programmes and which network settings to download on to the corresponding equipment unit, based on the assignment table, if this complementary but non mandatory information with respect to the operation of the device has previously been indicated by the operator.

During a subsequent step 110, the assignment software application 60 assigns the said one or more configuration elements to be downloaded on to each equipment unit based on the assignment table and indicator identified for each equipment unit.

Then during a step 112, the device 10 downloads on to the corresponding equipment unit 4a, 4b, 4c, via the downloading software application 56, the network settings, the configuration file and the programme or programmes, associated in the assignment table, with the corresponding equipment unit and with the indicator of the equipment unit, and assigned during the step of assignment 110.

Then, following the step 112 of downloading, during the step 114, the device 10 tests whether the assignment of network settings has indeed been properly performed, by connecting to the equipment unit, based on the network settings configured during the step of downloading 112. The network settings configured are included in the assignment table. In order to indicate to the operator whether the assignment of network settings has indeed been properly performed, the device 10 and/or the corresponding equipment unit transmits a signal to the operator, via for example, the command from an LED, not represented, and belonging to the device 10 or to the corresponding equipment unit.

Subsequently, during a step 116, the device 10 retrieves, via the second identification software application 64, the unique identifier of the equipment to which it is connected, and is thus capable of associating with each operation performed, during the step of downloading 112, the identifier of the corresponding equipment unit.

During a step 118, a traceability file for the operations performed is generated and associates the identifier of the equipment unit with each operation saved and stored. Then, during a step 120, the device 10 saves and stores the network settings, the configuration files and/or the software programmes downloaded during the step of downloading 112, and generates the configuration file from the server 30 based on these elements.

Finally, during a step 122, the configuration file from the server 30 is exported, by making use of the file export member 80, to the server 30.

In addition, during the step 122, the traceability file is exported, by making use of the file export member 80 and the transmitter/receiver 34, as well as the antenna 36, to the configuration module 24.

Again in addition, following the step 122, the network settings, the configuration files and/or the programme or programmes downloaded during the downloading step 112, and saved and stored during the step 120, are transmitted to the configuration module 24 and displayed by means of the display member 46.

In the second embodiment shown in FIG. 3, an initial step 200 consists of the recording and storing by the device, and more precisely by the first recording and storing software application 72, of a reference IP address. The reference IP address corresponds, for example, to the value of the first IP address to be used and to be downloaded.

In addition and as presented in the first embodiment, during the step 200 of recording and storing, the device 10 records and stores the configuration elements for each equipment unit 4a, 4b, 4c, the said configuration elements including, for example, a subnet mask to be used to define a range of IP addresses suitable for being assigned by the device to the equipment units.

During a subsequent step 202, the device 10 is successively connected to each equipment unit in turn.

Then, following each connection being made, during a step 204, the corresponding equipment unit 4a, 4b, 4c is detected by the device 10 and communication is established between the corresponding equipment unit 4a, 4b, 4c and the device 10.

Then, during a subsequent step 206, the IP address is incremented by the reference value based on the reference IP address, that is to say, for example, that the last digit of the reference IP address is incremented by one following each connection being made by the device 10 to an equipment unit. The incremented IP address is then saved and stored as a new reference IP address.

During a step 208, the device 10 downloads on to the corresponding equipment unit the incremented IP address.

Subsequently, the device 10 performs a step 210 similar to the step 114 previously presented above, as well as the steps 212, 214, 216, and 218, respectively similar to the steps 116, 118, 120 and 122 previously presented above, it being known that during these steps only the IP address downloaded on to the corresponding equipment unit is considered. More precisely, during the step 214 the traceability file associates with each IP address download, a date and the unique identifier for the corresponding equipment unit. During the step 216 of saving and storing, the saved and stored settings are the downloaded IP addresses and the configuration file generated includes these IP addresses.

According to a variant embodiment when the indicator associated with each equipment unit corresponds for example to the type of the equipment unit, during the step 200 the device 10 records and saves a reference IP address for each different indicator. Then, following the step 204 and prior to the step 206, the device 10 carries out the steps similar respectively to the steps 108, 110. Subsequently, during the step 206, the IP address is incremented by the reference value based on the reference IP address associated with the previously identified indicator. The incremented IP address is then recorded and stored as the new reference IP address associated with the said indicator. Then, during the downloading step 208, the device 10 also downloads on to the corresponding equipment unit the configuration elements recorded and stored during the step 200 and associated with the corresponding equipment unit. Then, the device 10 performs the steps 210, 212, 214, 216, 218 previously presented above.

According to another variant embodiment, if during the step 206 of incrementation, the value of the IP address is not included in the IP address range defined by the net mask recorded and stored during the step 200, the device is capable of sending an error message to the operator.

The second embodiment of the invention ensures the possibility, by simply fixing one or more reference IP address, of being able to configure the IP address of all of the equipment units to be connected to the same network. Thus, in the event of the number of equipment units to be configured being very significant, that is to say of the order of several hundreds, the second embodiment provides the ability to quickly configure these equipment units and to do this without performing any particular operation, apart from ensuring the connection of the device 10 to each equipment unit 4a, 4b, 4c.

Moreover in this second embodiment, it is also not necessary to define an assignment table, it is sufficient to simply set the reference IP address or addresses, this configuration method is therefore simple and quick to perform.

Finally, upon each connection being made by the device 10 to one of the equipment units 4a, 4b, 4c, the IP address downloaded by using the downloading software application 56, on to the corresponding equipment unit, is different, which provides the ability to ensure the uniqueness of the IP address of each equipment unit.

The second embodiment makes it possible to assign in a simple and rapid manner, an IP address to one of the Ethernet equipment units meant to be part of a network without using:
dedicated tools for configuring the IP addresses of equipment units involving the use of a computer,
physical mechanisms that are specific to the equipment units and enable them to be associated with the unique identifier,
a DHCP server,
   and prior to the physical constitution of the Ethernet network.

The device 10 presented here above is appropriate for creating the two embodiments presented and the operator is, for example, able to choose the configuration method in accordance with the first and the second embodiments based on its application, the information and data available to them and the equipment units to be configured.

The characteristic features of the embodiments envisaged here above may be combined with each other.

1. A configuration device for configuring a plurality of equipment units, each equipment unit having an Ethernet connector, the configuration device comprising:
a mating Ethernet connector capable of being connected successively to each Ethernet connector via a point to point link,
a first recording and storage means for recording and storing the reference network settings, and
a downloading means capable of downloading the reference network settings on to each equipment unit,
characterised in that the configuration device comprises:
a detection means capable of detecting the connection of the configuration device to a corresponding equipment unit, and
an assignment means capable of assigning, following the detection of the said connection, a unique IP address to the equipment unit to which the configuration device is connected, the said unique IP address being included in the reference network settings meant to be downloaded into the corresponding equipment unit.

2. A configuration device according to claim 1, wherein the first recording and storage means is capable of saving and storing an assignment table comprising of at least, for each equipment unit, one configuration element selected from among: the reference network settings, a configuration file and one or more programmes meant to be executed by the equipment units, the said one or more configuration elements being meant to be downloaded on to the corresponding equipment unit, wherein the configuration device includes a management means capable of managing the assignment table, wherein the assignment means is capable of assigning to the equipment unit to which it is connected, the said one or more configuration elements, based on the assignment table, and wherein the downloading means is capable of downloading on to the equipment unit to which it is connected the one or more configuration elements assigned.

3. A configuration device according to claim 1, wherein the network settings include a reference IP address, and wherein the assignment means is capable of incrementing by a reference value the reference IP address in order to determine the unique IP address associated with the corresponding equipment unit, following each connection made by the configuration device to one of the equipment units.

4. A configuration device according to claim 2, wherein an indicator is associated with each equipment unit, wherein the configuration device comprises a first identification means capable of identifying the indicator of the equipment unit to which it is connected, and wherein the said one or more configuration elements contained in the assignment table are functions of the indicator associated with each equipment unit.

5. A configuration device according to claim 4, wherein the reference network settings include a reference IP address for each different indicator, and wherein, following each connection made by the configuration device to one of the equipment units, the assignment means is capable of incrementing by a reference value the reference IP address associated with the indicator of the corresponding equipment unit in order to determine the unique IP address associated with the corresponding equipment unit.

6. A configuration device according to claim 1, wherein the configuration device comprises a second identification means capable of retrieving an identifier of each equipment unit, the identifier being unique for each equipment unit, wherein the configuration device includes a second recording and storage means capable of saving and storing each operation executed by the downloading means and capable of generating a traceability file for the operations performed, and wherein the second recording and storage means associates the unique identifier of the corresponding equipment unit with each equipment unit and with each operation saved and stored.

7. A configuration device according to claim 2, wherein the configuration device comprises a second identification means capable of retrieving an identifier of each equipment unit, the identifier being unique for each equipment unit, wherein the configuration device includes a second recording and storage means capable of saving and storing each operation executed by the downloading means and capable of generating a traceability file for the operations performed, and wherein the second recording and storage means associates the unique identifier of the corresponding equipment unit with each equipment unit and with each operation saved and stored.

8. A configuration device according to claim 7, wherein the second recording and storage means is capable of saving and storing the said one or more configuration elements downloaded on to each equipment unit, and wherein the configuration device includes a server, capable of again downloading the said one or more configuration elements on to each equipment unit, a generation means capable of generating a configuration file from the server based on the said one or more configuration elements saved and stored by the second recording and storage means and a file export member for exporting the configuration file to the server.

9. A configuration device according to claim 1, wherein the configuration device is portable and comprises an autonomous electrical power supply, and wherein the configuration device also comprises a wireless communication means.

10. A configuration method for configuring a plurality of equipment units by making use of a configuration device, each equipment unit having an Ethernet connector, the configuration device comprising a mating Ethernet connector capable of being connected successively to each Ethernet connector via a point to point link, the method comprising of the following steps:
a) the saving and storing of reference network settings,
b) the successive connection of the configuration device to each equipment unit,
c) the downloading of the reference network settings on to each equipment unit, characterised in that the method includes, prior to the step of downloading and after the step of connecting, the following steps of:
b1) the detection by the configuration device of the connection to the equipment unit to which it is connected, and
b2) the assignment by the configuration device, following the detection of the said connection, of a unique IP address to the equipment unit to which the configuration device is connected, the said unique IP address being included in the reference network settings to be downloaded into the corresponding equipment unit.

11. A method according to claim 10, wherein prior to the step of recording and storing the method includes the following step:
a1) the definition of an assignment table comprising of at least, for each equipment unit, one configuration element selected from among: the reference network settings, a configuration file and one or more programmes meant to be executed by the equipment units, the said one or more configuration elements being meant to be downloaded on to the corresponding equipment unit to which the configuration device is connected,
wherein during the step of assignment the configuration device assigns to the equipment unit to which it is connected the said one or more configuration elements, based on the assignment table, and wherein during the step of downloading, the downloading means downloads on to the corresponding equipment unit the said one or more configuration elements assigned.

12. A method according to claim 10, wherein during the step of recording and storing a user records and stores in the configuration device a reference IP address, wherein following each connection made by the configuration device to one of the equipment units, the configuration device performs the steps of assignment and downloading, wherein, during the step of assignment, the reference IP address is incremented by a reference value, and wherein during the step of downloading, the reference IP address incremented is downloaded on to the equipment unit to which the configuration device is connected and recorded and stored as the new reference IP address.

13. A method according to claim 11, wherein during the step of recording and storing a user records and stores in the configuration device a reference IP address, wherein following each connection made by the configuration device to one of the equipment units, the configuration device performs the steps of assignment and downloading, wherein, during the step of assignment, the reference IP address is incremented by a reference value, and wherein during the step of downloading, the reference IP address incremented is downloaded on to the equipment unit to which the configuration device is connected and recorded and stored as the new reference IP address.

14. A method according to claim 11, wherein during the step of definition, the data and information contained in the assignment table are functions of an indicator associated with each equipment unit, wherein after the detection step, the method includes a further step consisting of:
the identification of the indicator of the equipment unit to which it is connected, and wherein during the assigning step, the said one or more configuration elements assigned depend on the indicator of the equipment unit to which the configuration device is connected.

15. A method according to claim 14, wherein during the step of recording and storing, a user records and stores in the configuration device a reference IP address for each different indicator, wherein following each connection made by the configuration device to one of the equipment units, the configuration device performs the steps of identification, assignment and downloading, wherein, during the assignment step, the reference IP address associated with the indicator of equipment unit, identified during the identification step, is incremented by a reference value, and wherein during the downloading step, the incremented reference IP address is downloaded on to the equipment unit to which the configuration device is connected and recorded and stored as the new reference IP address associated with the corresponding indicator.

16. A method according to claim 10, wherein following the step of downloading, the configuration device performs a subsequent step consisting of:
the test to ensure that the downloading of network settings has been successfully performed, by connecting the configuration device to the equipment unit based on using the network settings downloaded during the downloading step.

17. A method according to claim 11, wherein the configuration device includes a server capable of again downloading the said one or more configuration elements on to each equipment unit, and wherein following each step of downloading the configuration device carries out the following steps:
the saving and storing of the said one or more configuration elements downloaded on to each equipment unit,
the generation of a configuration file from the server based on the configuration elements saved and stored, and
the exporting of the configuration file to the server.

18. A method according to claim 14, wherein the configuration device includes a server capable of again downloading the said one or more configuration elements on to each equipment unit, and wherein following each step of downloading the configuration device carries out the following steps:
the saving and storing of the said one or more configuration elements downloaded on to each equipment unit,
the generation of a configuration file from the server based on the configuration elements saved and stored, and
the exporting of the configuration file to the server.
